(19) United States
(12) Patent Application Publication
(10) Pub. No.: US 2006/0213887 A1
(43) Pub. Date: Sep. 28, 2006

(54) WELDING-TYPE DEVICE POWER INPUT SYSTEM

(76) Inventors: Charles L. Kaufman, Neenah, WI (US); Mike Baeten, De Pere, WI (US)

Correspondence Address: ZIOLKOWSKI PATENT SOLUTIONS GROUP, SC (ITW), 14135 NORTH CEDARBURG ROAD, MEQUON, WI, 53097, US

(21) Appl. No.: 10/907,198

(22) Filed: Mar. 24, 2005

(51) Int. Cl. B23K 9/10

(52) U.S. Cl. 219/130.1

(57) ABSTRACT

A power cord system for powering a welding-type device from a plurality of distinct outlet configurations is disclosed. The power cord system includes a first power cord constructed to electrically connect the welding-type device to a first outlet and a second power cord constructed to electrically connect the welding-type device to a second outlet configured differently than the first outlet.

### BACKGROUND OF THE INVENTION

The present invention relates generally to welding-type devices, and more particularly, to a power cord system for communicating different power signals to a welding-type device.

Known welding-type devices generally include a power source that is constructed to generate a power signal suitable for welding-type applications from a power signal input to the welding-type device. The power signal delivered to the welding-type device can be provided from an internal generator powered by an internal combustion engine or another external power source such as a conventional outlet. Conventional wall outlets are provided in a plurality of prong configurations wherein different prong configurations may provide the same or different power signals. Typical power signals provided at such outlets can include 110-115V, 15A; 110-115V, 20A; and 215-230V, 50A power signals, the latter of which can be configured differently in residential versus industrial applications. It is understood that these particular power signals are merely exemplary and other types of power signals can commonly be delivered to an electrical outlet for powering devices connected thereto.

Welding has applications in many industries and in many situations that arise therein. In any dynamic work environment, repairs or manufacturing may not always be easily and efficiently completed at one workstation. That is, a significant portion of the welding-type device operation is completed at locations remote from a storage or fixed location. Due in part to the new compact designs of welding-type devices and resulting ease of portability, these welding-type devices can now be moved about a work environment or from one location to another wherever welding-operations might be required. Often times, the electrical supplies throughout a facility, or from one location to another, are not uniform. That is, a different location may have power signals that are different than the power signal that the welding-type device is currently configured to receive.

In such circumstances, prior welding-type devices require that the plug or the entire cord of the welding-type device be changed to engage a respective outlet. Changing the plug of such systems requires physically severing the cord attached to the plug and individually connecting the wires of the cord to each terminal for each prong of the new plug. Merely changing the plug of the power cord creates the potential that a power signal will be communicated to the welding-type device that the welding-type device is ill-equipped to receive. Alternatively, changing the entire power cord of such systems requires removing the housing cover, removing the individual wires of the original power cord from connection to the welding-type device, attaching the individual wires of the new power cord thereto, and then replacing the housing cover to the welding-type device. Such welding-type devices are typically configured to engage only one power cord and connecting an alternate power cord requires physically disconnecting each of the individual conductors of a first power cord and connecting each of the individual conductors of the alternate power cord. Changing the cord in such a manner presents the potential that an operator may inadvertently connect the power cord improperly to the welding-type device. Improper connection of the welding-type device to a power source could result in machine malfunction, machine inoperability, or damage to the components thereof. Additionally, repeatedly changing the plug or the entire cord of known welding-type devices is time consuming and reduces process efficiency.

Still other welding-type devices provide a single power cord having multiple adapters connectable thereto. Such systems present the potential for loss of the relatively small adapters and/or damage thereto such that the adapters, after relatively minimal use, are inadvertently damaged due to exposure to the work environment. Additionally, should the end of the power cord which engages the respective adapters become damaged such that it cannot engage an adapter, the welding-type device is rendered completely inoperable until a replacement power cord can be acquired. As such, although such systems are capable of engagement with multiple differently configured outlets, multiple adapter systems are not without drawbacks.

Whether an operator changes the entire cord, the plug associated with the welding-type device or an adapter connectable thereto, the operator may also be required to adjust the controls of the welding-type device to configure the power supply of the welding-type device to generate a welding-type power from the particular power signal supplied to the welding-type device. Such adjustment configures the welding-type device to operate with the particular input characteristics of the power signals. Failure to properly configure the power source of the welding-type device to receive the power signals delivered thereto can result in damage to or in-operability of the electrical components of the welding-type device or damage to the source to which it is connected. As such, to adapt a welding-type device to operate at an alternate input power, an operator must be attentive to the physical connection of the individual conductors of the power cord to either the appropriate prongs of a plug or the appropriate connectors of the power supply of the welding-type device. Furthermore, the operator must also ensure that the controls of the welding-type device are configured for proper operation of the welding-type device with the power signal delivered thereto.

It would therefore be desirable to have a system and welding-type device capable of quickly and efficiently connecting to a plurality of differently configured outlets such that the welding-type device is operable upon connection to any one of a plurality of different input signals.

### BRIEF DESCRIPTION OF THE INVENTION

The present invention provides a system of connecting a welding-type device to a plurality of outlet configurations that overcome the aforementioned drawbacks. Moreover, the outlet configurations can have similar or different electrical signal characteristics. The power cord system includes a first power cord and a second power cord wherein each power cord has a first end that is removably connectable to a welding-type device and a second end operably engageable with an outlet.

In accordance with one aspect of the present invention, a power cord system is disclosed that includes a first power cord and a second power cord, each power cord constructed to communicate power to a welding-type power source having at least two differently configured inputs. The first power cord is constructed to communicate power to the welding-type power source and has one end configured to engage a first source of power and another end configured to engage one of the two differently configured inputs of the welding-type power source. The second power cord is also constructed to communicate power to the welding-type power source and has one end configured to engage a second source of power and another end configured to engage another of the at least two differently configured inputs of the welding-type power source.

According to another aspect of the present invention, a welding-type device is disclosed. The welding-type device includes a housing having a power supply positioned therein and constructed to generate a welding-type power. The welding-type device includes a first receptacle and a second receptacle, each electrically connected to the power supply. The first receptacle is configured to deliver a first power signal to the power supply and the second receptacle is configured to deliver a second power signal different than the first power signal to the power supply.

According to a further aspect of the present invention, a welding-type apparatus is disclosed that has a power supply positioned in a housing. The power supply is configured to generate a weld power from a signal received from one of a first input and a second input. A door is movably connected to the housing and is constructed to selectively expose at least one of the first and the second inputs.

Various other features, objects and advantages of the present invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is a perspective view of a welding-type device according to the present invention.

FIG. 2 is an elevational view of the welding-type device of FIG. 1 with a first power cord connected thereto.

FIG. 3 is an elevational view of the welding-type device of FIG. 2 with the first power cord removed therefrom and a second power cord connected thereto.

FIG. 4 is a perspective view of the receptacles of the welding-type device with the first and the second power cords removed therefrom and a door exploded from the welding-type device.

### DETAILED DESCRIPTION OF THE PREFERRED EMBODIMENT

As one skilled in the art will fully appreciate, the hereinafter description of welding-type devices not only includes welders but may also include any system such as heating and cutting systems. Additionally, a person skilled in the art will further appreciate that the present invention is applicable to any device that may be operated at a plurality of different input power signals. Reference to welding power, welding-type device, welding-type power, or welders generally, includes welding, cutting, or heating power. Description of a welding-type apparatus or device illustrates just one embodiment in which the present invention may be implemented. Understandably, the present invention is equivalently applicable with other systems that are desirable to be powered by one of multiple distinct power signals.

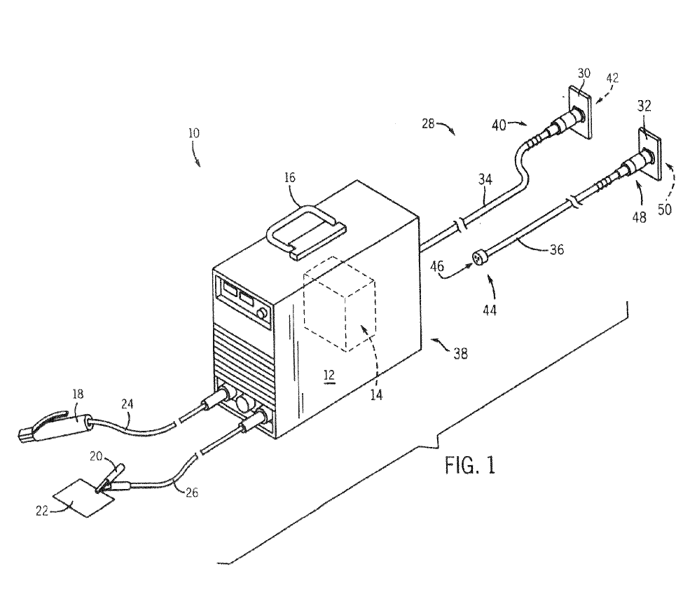

Referring now to FIG. 1, a perspective view of a welding device 10 incorporating the present invention is shown. Welding device 10 includes a housing 12 enclosing the internal components, including a welding-type power supply 14 and other components necessary for carrying out a particular welding-type process. Power supply 14 is constructed to receive an input power and generate a welding-type power therefrom. Optionally, the welding device 10 includes a handle 16 attached to housing 12 for transporting the welding system from one location to another. To effectuate the welding process, such as TIG or MIG welding or plasma cutting, the welding device includes a torch 18 as well as a work clamp 20. The work clamp 20 is configured to ground a workpiece 22 to be welded. As is known, when an electrode or consumable weld wire (not shown) extending from torch 18 is positioned in relative proximity to workpiece 22, a welding arc or cutting arc results, depending upon the particular welding process desired. A pair of cables 24 and 26 electrically connect torch 18 and work clamp 20 to the welding-type power supply 14 located in housing 12, respectively.

As shown in FIG. 1, welding device 10 includes a power cord system 28 constructed to electrically connect welding-type power supply 14 with an external power source such as a power grid represented by outlets 30, 32. Power cord assembly 28 includes a first power cord 34 and a second power cord 36. As shown, first power cord 34 includes a first end 38 electrically connected to welding-type power supply 14 and a second end 40 engaged with outlet 30. When first power cord 34 is connected between outlet 30 and welding device 10, power cord 34 electrically connects power supply 14 of welding device 10 to a power grid. Second end 40 of first power cord 34 has a plurality of prongs 42 extending therefrom which electrically engage outlet 30. Such a construction allows an operator to quickly and efficiently electrically connect and disconnect welding device 10 to an electrical outlet having a particular configuration.

Understandably, outlet 30 and prongs 42 of first power cord 34 are constructed to operatively engage one another. That is, outlet 30 could have any conventional configuration, or a unique configuration, provided prongs 42 are similarly oriented to engage therewith. Outlet 32 can also have any conventional or unique configuration but is simply configured different than outlet 30 or is connected to a power grid providing a different power signal thereat. For example, outlet 30 could be configured as a 115V outlet and outlet 32 could be configured as a 230V outlet. Alternatively, outlet 30 could be configured as a 50A residential outlet and outlet 32 could be configured as a 50A industrial outlet. Regardless of the configuration of outlets 30 and 32, power cords 34 and 36 are constructed to engage therewith, respectively, and communicate the variable power signals thereof to welding device 10. Understandably, these configurations are merely exemplary and in no way limit to the scope of the claims herein. Additionally, although only two power cords are shown, it is envisioned that additional power cords could be provided to engage additional differently configured outlets.

As shown in FIG. 1, power cord 36 includes a first end 44 having a plurality of receptacles 46 formed therein. As discussed below with respect to FIG. 3, receptacles 46 are configured to removably engage welding device 10. A second end 48 of power cord 36 has a plurality of prongs 50 which extend therefrom and operatively engage outlet 32. As previously discussed, outlet 32 is configured differently than outlet 30. As such, plurality of prongs 50 of second power cord 36 are preferably configured differently that plurality of prongs 42 of first power cord 34. Accordingly, a welding-type device equipped with power cord system 28 is operatively connectable to a plurality of outlets providing a plurality of input power signals. A welding-type device equipped according to the present invention can be quickly and efficiently configured for operation at any of the plurality of power signals.

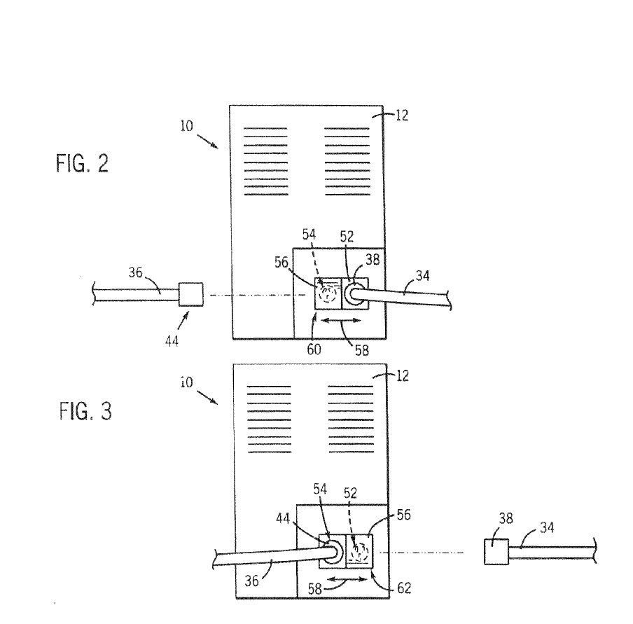

As shown in FIG. 2, welding device 10 has a first receptacle 52 and a second receptacle 54 electrically connected to the power supply thereof. First end 38 of first power cord 34 is connected to first receptacle 52 of welding device 10 and an optional door 56 is positioned over second receptacle 54. Optional door 56 is slideably connected to housing 12 of welding device 10 such that, as shown in FIGS. 2 and 3, door 56 covers the receptacle 52, 54 that does not have a power cord engaged therewith. Door 56 is attached to housing 12 and is movable in the directions generally indicated by arrow 58. As shown in FIG. 2, door 56 is positioned in a first position 60 such that the door covers second receptacle 54 and, as shown in FIG. 3, door 56 is movable to a second position 62 wherein the door covers first receptacle 52. Such a construction prevents inadvertent contact with the electrical contacts of the unused receptacle 52, 54 and also prevents multiple power cords from being concurrently connected to welding device 10. Alternatively, it is understood that optional door 56 could include a plurality of individual doors oriented to bypass one another such that each receptacle is covered when no power cord is connected to the welding device. Yet another alternative of optional door 56 would include a plurality of individual doors pivotally or removably attached to the welding device such that each receptacle of the welding device could be individually accessed without interference of the respective door with any other receptacle.

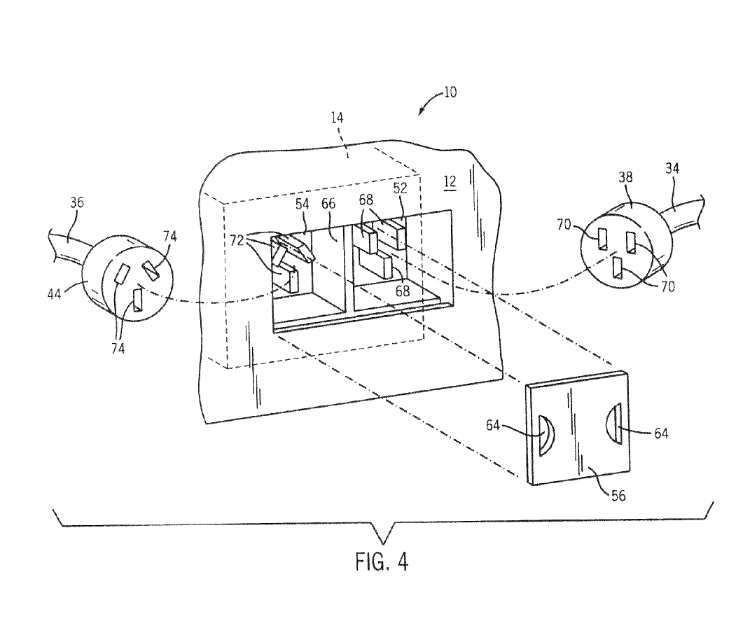

Referring back to FIG. 2, first end 38 of first power cord 34 is shown engaged with first receptacle 52 of welding device 10. Optional door 56 prevents first end 44 of second power cord 36 from engaging second receptacle 56. Additionally, as will be discussed below with respect to FIG. 4, the configuration of contacts of first receptacle 52 is such that first end 44 of second power cord 36 is not engageable therewith. Such a construction prevents welding device 10 from being connected to a source of power the receptacle is not configured to receive.

As shown in FIG. 3, when an electrical outlet configuration is available that is not compatible with first power cord 34, first end 38 of first power cord 34 can be removed from first receptacle 52 without the use of tools. Optional door 56 is located in second position 62 over first receptacle 52 thereby exposing second receptacle 54. First end 44 of second power cord 36 is configured to engage second receptacle 54 of welding device 10 and thereby connect the welding device to an alternately configured source of power. Understandably, welding device 10 could include more than two receptacles wherein each receptacle is configured to engage a respective power cord and thereby, allow operation of the welding device so equipped at a plurality of different input power parameters and/or a plurality of differently configured outlets. As such, a welding device according to the present invention is efficiently adaptable to operation at a plurality of distinct power signals and a plurality of distinct outlet configurations.

FIG. 4 shows welding device 10 with optional door 56 removed from housing 12 thereof. Door 56 includes a pair of recesses 64 to allow efficient movement of the door by an operator of welding device 10. Removing optional door 56 concurrently exposes first receptacle 52 and second receptacle 54 of welding device 10. A wall 66 separates first and second receptacles 52 and 54, respectively, and is positioned to allow optional door 56 to pass thereover when the door is connected to housing 12. First receptacle 52 includes a plurality of prongs or contacts 68 configured to operatively engage a plurality of recesses 70 formed in first end 38 of first power cord 34. Each recess of the plurality of recesses 70 is slideably engageable with a respective contact of the plurality of contacts 68 such that when first end 38 of first power cord 34 is engaged with receptacle 52 of welding device 10, power is communicated from a wall outlet to the individual contacts 68 of receptacle 52.

Second receptacle 54 includes a plurality of contacts 72 configured to engage a plurality of recesses 74 formed in first end 44 of second power cord 36. Each recess of the plurality of recesses 74 is constructed to slideably engage a respective contact of plurality of contacts 72. As such, second power cord 36 communicates the power signal provided at an outlet to weld power supply 14 via plurality of contacts 72. Contacts 68 of first receptacle 52 and contacts 72 of second receptacle 54 are electrically connected to weld power supply 14 such that the weld power supply can generate a power signal suitable for welding applications without operator interference. That is, contacts 68 and 72 are connected to power supply 14 such that welding device 10 automatically determines the characteristics of a power signal input into the welding device. Such a construction allows the welding device to be operated at a plurality of distinct input power signals without operator control setting. Alternatively, in those systems that include optional door 56, power supply 14 is configured to operate at an input power signal as determined by the position of door 56. That is, the position of the door sets the operating parameters of the welding device such that weld power can be generated from a plurality of different input power parameters without operator interference other than connecting the respective power cord. Yet another alternative allows an operator of welding device 10 to manually set the welding device for operation from an intended input power signal. Such a welding device is operational at multiple input power signals having varied power parameters.

Additionally, as shown, the configuration of plurality of contacts 68 is unique in that first end 44 of second power cord 36 is not connectable to first receptacle 52. Similarly, the configuration of recesses 70 of first end 38 of first power cord 34 prevents engagement of first power cord 34 with second receptacle 54 of welding device 10. Such a construction prevents inadvertent connection of a power cord with a receptacle of the welding device that is not configured to operate at the power parameters provided by the respective power cord. Alternatively, if the power supply of the welding type device is constructed to automatically determine the parameters of a power signal provided thereto, each first end of each power cord could be provided with a uniform recess configuration. The uniform recess configuration of the power cords would be constructed to engage a single receptacle or a plurality of receptacles having uniform contact configurations. The latter requiring an operator to associate a respective outlet power with a respective receptacle such as by color coding the multiple power cords and an associated receptacle of the welding device. Alternatively, it is understood that the second end of a power cord could be sized and/or shaped to engage a corresponding size and/or shaped receptacle of the welding-type power source. Any of the above constructions provides a welding device that is quickly and efficiently adaptable to operate at any one of a plurality of different input power signals.

It is further understood that first ends 38, 44 of first and second power cords 34, 36 each have a plurality of recesses 70, 74, respectively, and first and second receptacles 52, 54 of welding device 10 each include a plurality of contacts extending therefrom, is only one of many possible means for connecting welding device 10 and power cords 34, 36. An alternate connection could include first ends 38, 44 of power cords 34, 36 being provided with a plurality of prongs that extend therefrom and operatively engage a plurality of recesses formed in receptacles 52, 54, respectively. Any of these alternatives are envisioned and within the scope of the claims.

Therefore, the present invention includes a power cord system connectable to a welding-type device and configured to connect the welding-type device to alternate power supply configurations. The system includes a first power cord constructed to electrically connect the welding-type device to an outlet and a second power cord constructed to electrically connect the welding-type device to another outlet configured different that the outlet engageable by the first power cord.

The present invention also includes a power cord system having a welding-type power source having at least two differently configured inputs. A first power cord is constructed to communicate power to the welding-type power source and has one end configured to engage a first source of power and another end configured to engage one of the two differently configured inputs of the welding-type power source. A second power cord is constructed to communicate power to the welding-type power source and has one end configured to engage a second source of power and another end configured to engage another of the at least two differently configured inputs of the welding-type power source.

The present invention further includes a welding-type device having a power supply positioned in a housing and constructed to generate a welding-type power. The welding-type device includes a first receptacle and a second receptacle, each electrically connected to the power supply. The first receptacle is configured to deliver a first power signal to the power supply and the second receptacle is configured to deliver a second power signal different than the first power signal to the power supply.

The present invention also includes a welding-type apparatus having a power supply positioned in a housing and configured to generate a weld power from a signal received from one of a first input and a second input. A door is movably connected to the housing and is constructed to selectively expose at least one of the first and the second inputs.

The present invention has been described in terms of the preferred embodiment, and it is recognized that equivalents, alternatives, and modifications, aside from those expressly stated, are possible and within the scope of the appending claims.

What is claimed is:

1. A power cord system comprising:
a welding-type power source having at least two differently configured inputs;
a first power cord constructed to communicate power to the welding-type power source, the first power cord having one end configured to engage a first source of power and another end configured to engage one of the two differently configured inputs of the welding-type power source; and
a second power cord constructed to communicate power to the welding-type power source, the second power cord having one end configured to engage a second source of power and another end configured to engage another of the at least two differently configured inputs of the welding-type power source.

2. The power cord system of claim 1 further comprising a manually operated selector arranged to allow connection of only one the first source of power and the second source of power to the welding-type power source.

3. The power cord system of claim 1 wherein the welder further comprises a housing and a door movably attached to the housing to selectively expose one of the at least two differently configured inputs.

4. The power cord system of claim 3 wherein the door is constructed to have a first position and a second position, wherein the door obstructs the first power cord from engaging one of the two differently configured inputs and allows the second power cord to engage another of the two differently configured inputs in the first position, and allows the first power cord to engage one of the two differently configured inputs and obstructs the second power cord from engaging another of the two differently configured inputs in the second position.

5. The power cord system of claim 1 wherein the weld-type power source further comprises a power supply electrically connected to both of the at least two differently configured inputs and configured to generate a power signal suitable for welding applications from a power signal delivered from at least one of the first power cord and the second power cord.

6. The power cord system of claim 1 wherein the one end of the first cord is configured to engage a 115V source of power and the one end of the second cord is configured to engage a 230V source of power.

7. The power cord system of claim 1 wherein only one of the first cord and the second cord is connectable to the welder at a time.

8. A welding-type device comprising:
a housing;
a power supply positioned in the housing and constructed to generate a welding-type power;
a first receptacle electrically connected to the power supply and configured to deliver a first power signal thereto; and
a second receptacle electrically connected to the power supply and configured to deliver a second power signal different than the first power signal thereto.

9. The welding-type device of claim 8 further comprising a shutter connected to the housing and constructed to selectively expose at least one of the first and second receptacles.

10. The welding-type device of claim 9 wherein positioning of the shutter configures the power supply to generate the welding-type power from a power signal delivered from an exposed one of the first and the second receptacles.

11. The welding-type device of claim 8 further comprising a first power cord constructed to engage a first outlet and the first receptacle and a second power cord constructed to engage a second outlet configured different than the first outlet and the second receptacle.

12. The welding-type device of claim 11 wherein the first power cord is constructed to engage a 115V outlet and the second power cord is constructed to engage a 230V outlet.

13. The welding-type device of claim 8 wherein the first receptacle is configured generally similar to the second receptacle.

14. The welding-type device of claim 8 wherein the power supply is constructed to automatically determine which of the first receptacle and the second receptacle is providing power to the welding-type device.

15. A welding-type apparatus comprising:
a housing;
a power supply positioned in the housing and configured to generate a weld power from a signal received from one of a first input and a second input; and
a door movably connected to the housing and constructed to selectively expose at least one of the first and the second inputs.

16. The welding-type apparatus of claim 15 wherein when the door selectively exposes the first input, the door prevents access to the second input, and when the door selectively exposes the second input, the door prevents access to the first input.

17. The welding-type apparatus of claim 15 further comprising one power cord constructed to engage the first input and another power cord constructed to engage the second input, wherein the first and second inputs each have a set of prongs configured differently from one another.

18. The welding-type apparatus of claim 15 wherein the first input and the second input are configured to accept one of a different volts, amps, and volt/amps.

19. The welding-type apparatus of claim 15 wherein the first input is connected to the power supply to generate the weld power from a 115V input and the second input is connected to the power supply to generate the weld power from a 230V input.

20. The welding-type apparatus of claim 15 wherein the door has a first position that electrically connects the first input and the power supply and a second position that electrically disconnects the first input and the power supply.

21. The welding-type apparatus of claim 15 wherein the door is slidably attached to the housing.
